(19) United States
(12) Patent Application Publication
(10) Pub. No.: US 2006/0203514 A1
(43) Pub. Date: Sep. 14, 2006

(54) Light guide plate structure

(75) Inventor: Wen-Pao Tseng, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/074,651

(22) Filed: Mar. 9, 2005

(51) Int. Cl. F21V 7/04

(52) U.S. Cl. 362/615

(57) ABSTRACT

A backlight module installs a light guide plate, a plurality of optical films, and a liquid crystal display panel in order on an emergent plane of a light source, wherein the light guide plate forms more than one hollow layer within an incident side to an effective light emitting area and a light adjusting component disposed on one side or both sides of the hollow layer, such that the hollow layer of the light guide plate changes the light path of the light of the light source and the light adjusting component improves its reflectivity to effectively distribute and evenly emit the light towards each optical film. As a result, the dark band in each light source can be eliminated, and the light performance including luminance and evenness can be enhanced.

### BACKGROUND OF THE INVENTION

1. Field of the Invention

The present invention relates to an improved light guide plate structure of a backlight module, and more particularly to a light guide plate structure of a backlight module capable of preventing the formation of bright and dark bands.

2. Description of the Related Art

Referring to FIG. 1, a cross-sectional view of a conventional backlight module structure for a liquid crystal display is shown. The structure of the whole backlight module comprises a light guide plate 20 disposed at the bottom surface of a liquid crystal display panel 10, an optical film 30 formed by a prism or diffuser and installed at an emergent plane of the light guide plate 20, a reflective panel 40 installed at a reflective plane of the light guide plate 20, and a light source 50 installed on a side. If a light emitted from the light source 50 is projected to the light guide plate 20, the light will be guided and projected upward by the refraction and reflection of the light guide plate 20 and the reflective panel 40, and then the light will pass through the optical film 30 made of a prism or a diffuser to produce evener light emergent from the liquid crystal display panel 10. Since the requirements for the emergent light performance get higher, related manufacturers usually build a light adjusting structure 22 with a light reflective function on a reflective plane 21 of the light guide plate 20, and the shape of the light adjusting structure 22 could be circular, rectangular or linear. After a light source is reflected by the light adjusting structure 22, the light source is guided and emitted successfully to enhance the light performance. Alternatively, the design of the optical film 30 made of a prism or a diffuser is altered to improve the light performance including luminance and evenness.

### SUMMARY OF THE INVENTION

It is a primary objective of the present invention to provide an improved light guide plate structure, which forms at least one hollow layer within an incident side to an effective light emitting area in a panel of the light guide plate, and a light adjusting component is disposed on one side or both sides of the hollow layer, such that the light of a light source changes its path by the hollow layer in the light guide plate while the light adjusting component improves its reflectivity to effectively distribute and evenly emit the light.

In other words, the whole light guide plate produces a light path which is different from the traditional light path to the light of the light source. With more active and positive measures, the issue of having dark and bright bands according to the prior art liquid crystal modules can be overcome effectively, and thus the light of the light source can be distributed more effectively.

### BRIEF DESCRIPTION OF THE DRAWINGS

FIG. 1 is a schematic view of the structure of a conventional backlight module;

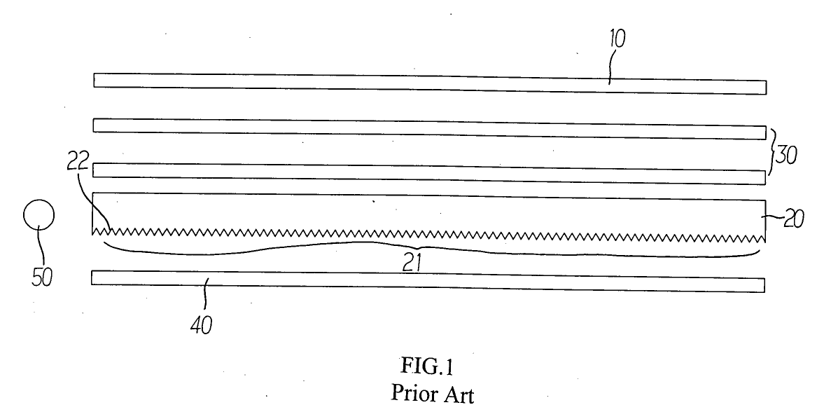

FIG. 2 is a schematic view of the structure of a backlight module of the present invention;

FIG. 3 is another schematic view of the structure of a backlight module of the present invention;

FIG. 4 is another further schematic view of the structure of a backlight module of the present invention;

FIG. 5 is a schematic view of a light path of a backlight module of the present invention; and

FIG. 6 is an exploded view of a backlight module according to another preferred embodiment of the present invention.

### DETAILED DESCRIPTION OF THE PREFERRED EMBODIMENTS

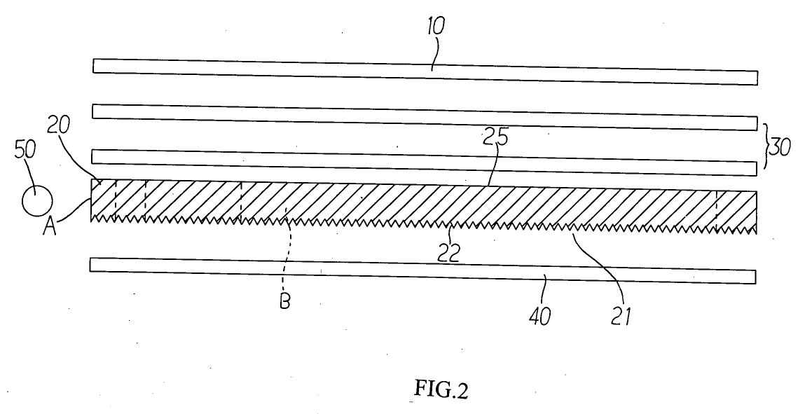

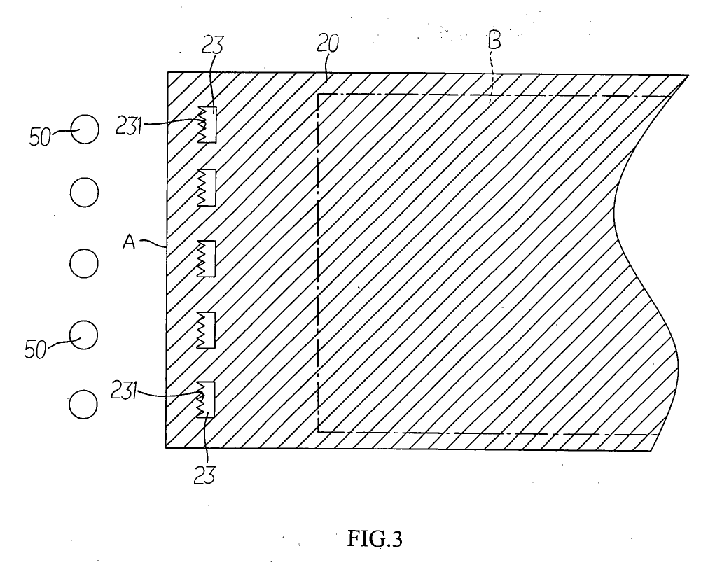

Referring to FIGS. 2, and 3, an improved light guide plate structure of the present invention is illustrated. In the figures, the basic structure of a whole backlight module also comprises a light guide plate 20 disposed at the bottom surface of a liquid crystal display panel 10, an optical film 30 formed by a prism or diffuser and installed at an emergent plane of the light guide plate 20, a reflective panel 40 installed at a reflective plane of the light guide plate 20, and a light source 50 installed on a side. If a light emitted from the light source 50 is projected to the light guide plate 20, the light will be guided and projected upward by the refraction and reflection of the light guide plate 20 and the reflective panel 40 and passed through the optical film 30 made of a prism or a diffuser to produce evener light emergent from the liquid crystal display panel 10.

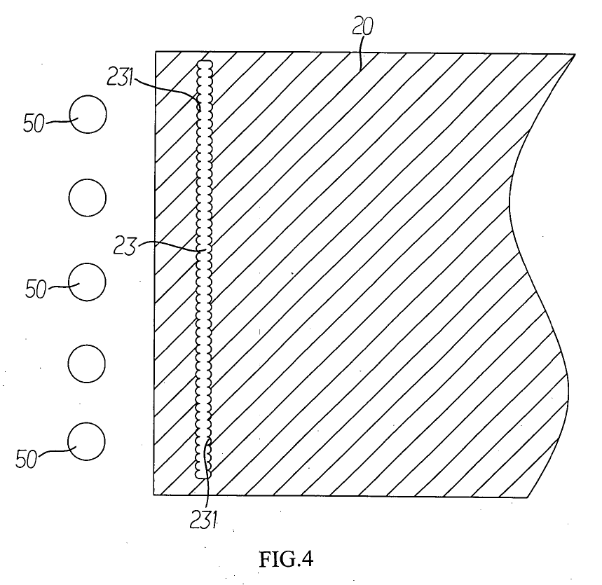

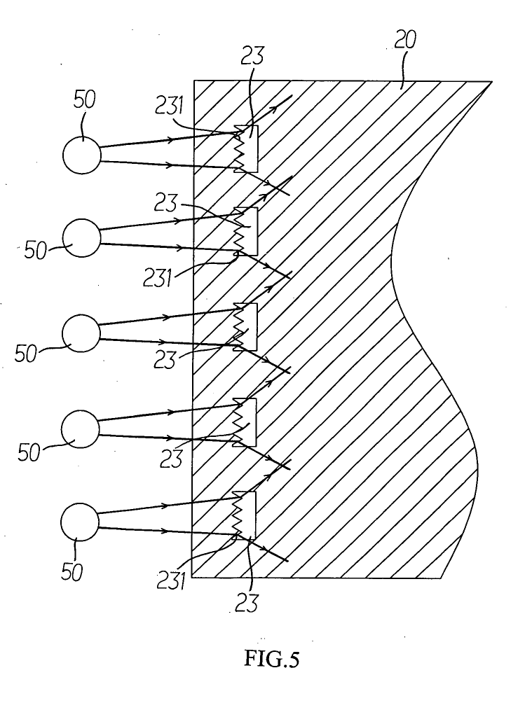

The technical characteristics of the present invention reside on that the light guide plate 20 forms more than one hollow layer 23 within an incident side A to an effective light emitting area B, and a light adjusting component 231 disposed on one side of the hollow layer 23, and the hollow layers 23 could be continuous (as shown in FIG. 4) or discontinuous (as shown in FIG. 3) and of various geometric shapes, wherein the hollow layers 23 are installed at the corresponding positions of the light sources 50, so that a light of the light source 50 changes its light path when passing through the hollow layers 23 as shown in FIG. 5 to effectively distribute and evenly emit the light, and the light is guided successfully to enhance its diffusion effect after being diffused by the light adjusting component 231. Of course, the light guide plate 20 can have a light adjusting component 22 with a light reflection function on a reflective plane 21 or an emergent plane 25, and the light adjusting component 22 could be in a form of various geometric shapes, so that the light goes through a reflection by the light adjusting component twice to improve the luminance and evenness of the light.

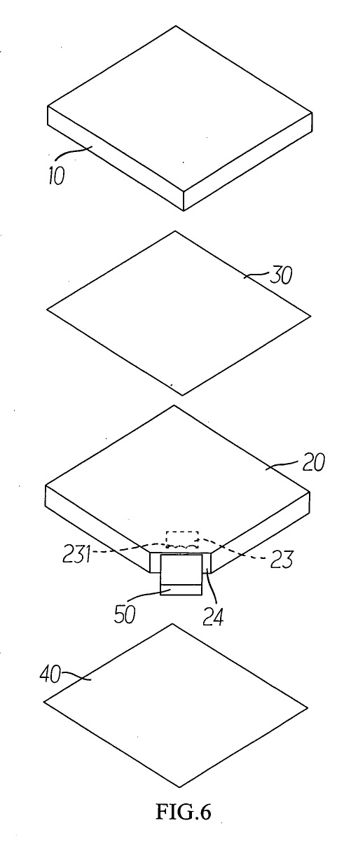

Referring to FIG. 6, the structure of a backlight module is shown. The light guide plate 20 further comprises an incident plane 24 at a corner section, and the incident plane 24 is a shape with an indented corner. The light source 50 is installed at the corner section, and the light enters into the light guide plate 20 through the incident plane 24. A reflective panel 40 is installed under the light guide plate 20, and the hollow layer 23 is disposed at a position corresponding to the light source 50. Similarly, the hollow layer 23 changes the light path of the light of the light source 50 so as to effectively overcome the issue of having bright and dark bands according to the prior art liquid crystal modules by more active and positive measures and distribute the light of the light source more effectively.

In summation of the above description, the present invention herein provides a feasible light guide plate structure and complies with the patent application requirements, and thus is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1-8. (canceled)

9. An improved light guide plate structure for a liquid crystal display (LCD) panel backlight module comprising:
a light guide plate having more than one hollow layer disposed within a side of the light guide plate incident to an effective light emitting area;
a reflective panel under the light guide plate:
a plurality of optical films above the light guide plate;
a liquid crystal display (LCD) panel above the plurality of optical films,
a light source located on a side of the light guide plate, wherein the light guide plate, the reflective panel, the plurality of optical films and the liquid crystal display panel are all located on an emergent plane of the light source; and
a light adjusting component disposed at one end of a hollow layer, the light adjusting component being positioned to diffuse light reflected from the reflective panel to thereby change the light path of the light from the light source to effectively distribute and evenly emit the light.

10. The improved light guide plate structure of claim 9, wherein the light guide plate has an incident plane disposed at a corner section of the light guide plate, and the incident plane is in a shape having a truncated corner, the light source being installed at said corner section such that said light enters the light guide plate from the incident plane.

11. The improved light guide plate structure of claim 9, wherein the light adjusting component has a curved surface.

12. The improved light guide plate structure of claim 9, wherein the light adjusting component has an angular surface.

13. An improved light guide plate structure for a liquid crystal display (LCD) panel backlight module comprising:
a light guide plate having more than one hollow layer disposed within a side of the light guide plate incident to an effective light emitting area;
a reflective panel under the light guide plate:
a plurality of optical films above the light guide plate;
a liquid crystal display (LCD) panel above the plurality of optical films,
a light source located on a side of the light guide plate, wherein the light guide plate, the reflective panel, the plurality of optical films and the liquid crystal display panel are all located on an emergent plane of the light source; and
a light adjusting component disposed on both ends of a hollow layer, the light adjusting component being positioned to diffuse light reflected from the reflective panel to thereby change the light path of the light from the light source to effectively distribute and evenly emit the light.

14. The improved light guide plate structure of claim 13, wherein the light guide plate has an incident plane disposed at a corner section of the light guide plate, and the incident plane is in a shape having a truncated corner, the light source being installed at said corner section such that said light enters the light guide plate from the incident plane.

15. The improved light guide plate structure of claim 13, wherein the light adjusting component has curved surfaces.

16. The improved light guide plate structure of claim 13, wherein the light adjusting component has angular surfaces.
